(19) United States
(12) Patent Application Publication
(10) Pub. No.: US 2026/0077341 A1
(43) Pub. Date: Mar. 19, 2026

(54) Palladium Copper Single-Atom Alloy Catalyst for Nitrate Reduction

(71) Applicants: Yimin WU, Waterloo (CA); Cheng DU, Beijing (CN); Siyan LU, Kitchener (CA)

(72) Inventors: Yimin WU, Waterloo (CA); Cheng DU, Beijing (CN); Siyan LU, Kitchener (CA)

(21) Appl. No.: 19/125,875

(22) PCT Filed: Nov. 1, 2023
(86) PCT No.: PCT/CA2023/051459

§ 371 Date: Apr. 30, 2025

Related U.S. Application Data
(60) Provisional application No. 63/475,329, filed on Nov. 1, 2022.

(51) Int. Cl. B01J 23/89; B01J 35/45; B01J 37/34

(52) U.S. Cl. CPC B01J 23/8926; B01J 35/45; B01J 37/348; B01J 2235/30

(57) ABSTRACT

A palladium copper (PdCu) single-atom alloy (SAA) catalyst for nitrate reduction, as well as a method of nitrate reduction using the same, are provided. The PdCu SAA catalyst comprises a Cu substrate and at least one isolated Pd atom dispersed in a surface of the Cu substrate. The method of nitrate reduction comprises contacting the PdCu SAA catalyst with a nitrate source to selectively produce ammonia. The nitrate source can be waste water.

### CROSS REFERENCE TO PRIOR APPLICATIONS

The present application claims priority to U.S. Application No. 63/475,329 filed on Nov. 1, 2022, the entire contents of which are incorporated herein as if set forth in its entirety.

### TECHNICAL FIELD

The present disclosure relates generally to nitrate reduction and more particularly to electrocatalytic reduction of nitrate into ammonia (NH₃), which has applications in waste water treatment and particularly, in waste water nutrient recovery.

### BACKGROUND

This section provides background information related to the present disclosure which is not necessarily prior art.

With the rapid development of modern industry and agriculture, nitrate waste from industrial sewage and overfertilization has caused serious pollution in the biosphere and water bodies, which is threatening human health and ecological safety. At present, the removal of nitrate waste in waste water mainly relies on traditional methods such as biological, physical, and chemical treatments, such as bacterial denitrification, ion exchange, and reverse osmosis, which are severely limited by rigorous operation conditions, high cost of posttreatment, and tedious procedures.

Electrocatalytic nitrate reduction reaction (represented as NO₃⁻RR) technology driven by green electric energy has been reported to recover nutrition flexibly and effectively from nitrate in waste water, by catalyzing aqueous nitrate (NO₃⁻) reduction into N₂ (main product) and NH₃ (by-product) under ambient temperature and pressure (Zeng, Y. C., et al. Restoring the Nitrogen Cycle by Electrochemical Reduction of Nitrate: Progress and Prospects. Small Methods 4, 2000672 (2020); Xu, H. et al. Dendritic Cell-Inspired Designed Architectures toward Highly Efficient Electrocatalysts for Nitrate Reduction Reaction. Small 16, 2001775 (2020); Rosca, V., et al. Nitrogen Cycle Electrocatalysis. Chem. Rev. 109, 2209-2244 (2009)). However, the accessibility of such electrocatalytic technology in industrial treatment of nitrate waste still suffers from an intractable limitation that the main product N₂ possesses very limited economic value and is difficult to be reused (Andersen, S. Z. et al. A Rigorous Electrochemical Ammonia Synthesis Protocol with Quantitative Isotope Measurements. Nature 570, 504-508 (2019); Fang, C. et al. Pressure-Tailored Lithium Deposition and Dissolution in Lithium Metal Batteries. Nat. Energy 6, 987-994 (2021); Du, C. et al. Interface Hydrophobic Tunnel Engineering: A General Strategy to Boost Electrochemical Conversion of N₂ To NH₃. Nano Energy 92, 106784 (2022)).

Furthermore, the competitive hydrogen evolution reaction (HER) over the electrocatalyst occupies too many electrons from the nitrate reduction processes, resulting in a low Faraday efficiency (FE) of electrocatalytic NO₃⁻RR (Van Langevelde, P. H. et al. Electrocatalytic Nitrate Reduction for Sustainable Ammonia Production. Joule 5, 290-294 (2021); Xu, H., et al. Electrocatalytic Reduction of Nitrate—A Step Towards A Sustainable Nitrogen Cycle. Chem. Soc. Rev. 51, 2710-2758 (2022)).

Alkaline electrolytes have been proposed to suppress HER for selective NO₃⁻RR; however, their strong corrosivity to reactors would severely increase the economic cost of large-scale industrial applications (Hu, Q., et al. Reaction Intermediate-Mediated Electrocatalyst Synthesis Favors Specified Facet and Defect Exposure for Efficient Nitrate-Ammonia Conversion. Energy Environ. Sci. 14, 4989-4997 (2021); Ye, S., et al. Elucidating the Activity, Mechanism and Application of Selective Electrosynthesis of Ammonia from Nitrate on Cobalt Phosphide. Energy Environ. Sci. 15, 760-770 (2022); Liu, H., et al. Efficient Electrochemical Nitrate Reduction to Ammonia with Copper-Supported Rhodium Cluster and Single-Atom Catalysts. Angew. Chem., Int. Ed. 61, No. e20220255 (2022)).

Since NH₃ is an important precursor to produce fertilizer and urea for agriculture, there is a need for an electrocatalyst to catalyze nitrate reduction selectively and effectively into value-added NH₃ so as to increase the economic value of this process. Ideally, such catalyst may also serve to remove nitrate from waste water.

### SUMMARY

In one aspect, the present disclosure provides a PdCu SAA catalyst for nitrate reduction, wherein the catalyst comprises a Cu substrate and at least one isolated Pd atom dispersed in a surface of the Cu substrate. When there are more than one isolated Pd atoms, the isolated Pd atoms are present in the form of individual isolated atoms dispersed in the surface of the Cu substrate.

In a further aspect, the isolated Pd atoms are present in no more than about 0.1% total weight of the PdCu SAA catalyst. In some embodiments, the isolated Pd atoms are present in about 0.01 to 0.1% total weight of the PdCu SAA catalyst.

In a further aspect, the Cu substrate of the PdCu SAA catalyst comprises Cu nanoparticles. The Cu nanoparticles may have an average size of about 100 nm in diameter. The Cu substrate may also be polycrystalline.

In a further aspect, the PdCu SAA catalyst exhibits at least about 97.1% FE with a yield of about 15.4 μmol cm⁻² h⁻¹ towards a production of NH₃.

In a further aspect, the Cu substrate is supported by a support selected from the group consisting of carbon paper, carbon cloth and an electric conductive metal support. The electric conductive metal support may be selected from the group consisting of titanium, aluminum, nickel, tungsten and silver.

In another aspect, the present disclosure provides a method of nitrate reduction. The method comprises contacting a PdCu SAA catalyst comprising at least one isolated Pd atom dispersed in a surface of a Cu substrate with a nitrate source, and reducing nitrate in the nitrate source to produce NH₃ in the presence of the PdCu SAA catalyst. The contacting may comprise feeding the PdCu SAA catalyst to the nitrate source, or feeding the nitrate source to the PdCu SAA catalyst. The method may be carried out under neutral media such as at a pH of about 7.0. The method may also be carried out at room temperate. The nitrate source may be waste water.

### BRIEF DESCRIPTION OF THE FIGURES

The features of certain embodiments will become more apparent in the following detailed description in which reference is made to the appended figures wherein:

FIGS. 1A to 1F (collectively, FIG. 1) show standard curves of NH₃ from different detection methods as described in the present disclosure. FIGS. 1A and 1B: UV-Vis method with ¹⁴NH₄⁺; FIGS. 1C and 1D: ¹H-nuclear magnetic resonance spectroscopy (NMR) method with ¹⁴NH₄⁺; and FIGS. 1E and 1F: ¹H-NMR method with ¹⁵NH₄⁺.

FIGS. 2A to 2C (collectively, FIG. 2) show measurements of NO₂⁻ products in accordance with an embodiment of the present disclosure. FIGS. 2A and 2B: concentration-absorbance calibration curves of NO₂; and FIG. 2C: FE and yield of NO₂ products in an exemplary PdCu SAA catalyst and Cu.

FIGS. 3A to 3G (collectively, FIG. 3) show a general reaction scheme for the synthesis of a PdCu SAA catalyst in accordance with an embodiment of the present disclosure and scanning transmission electron microscopy (STEM) images of the exemplary PdCu SAA catalyst. FIG. 3A: schematic illustration of the synthesis of PdCu SAA; FIG. 3B: aberration-corrected high-angle annular-dark-field scanning transmission electron microscopy (AC-HAADF-STEM) image of the PdCu SAA; FIGS. 3C and 3D: enlarged AC-HAADF-STEM images of the PdCu SAA; FIG. 3E: STEM image of the PdCu SAA; and FIGS. F and G: scanning transmission electron microscopy and energy dispersive X-ray spectroscopy (STEM-EDS) mapping of Cu and Pd elements in the PdCu SAA.

FIGS. 4A to 4I (collectively, FIG. 4) are scanning electron microscopy (SEM) images of samples of an exemplary PdCu SAA catalyst. FIGS. 4A to 4C: Cu on blank carbon paper (CP); FIGS. 4D to 4F: PdCu SAA on CP; and FIGS. 4G to 4I: blank CP.

FIGS. 5A to 5E (collectively, FIG. 5) are AC-HAADF-STEM images of an exemplary PdCu SAA catalyst. FIG. 5A: Cu; and FIGS. 5B to 5E: PdCu SAA.

FIGS. 6A to 6E (collectively, FIG. 6) show results of structural characterization and Bader charge analysis of an exemplary PdCu SAA catalyst. FIG. 6A: grazing incidence X-ray diffraction (GI-XRD) spectra of the PdCu SAA and Cu; FIG. 6B: Pd K-edge X-ray absorption near-edge structure (XANES) and extended X-ray absorption fine structure (EXAFS) of the PdCu SAA and Pd foil reference with the inset image being the enlarged spectra; FIG. 6C: Bader charge analysis of the PdCu SAA with Cu (100), the sphere of a lighter shade representing Cu, and the sphere of a darker shade representing Pd atoms; FIG. 6D: Pd K-edge Fourier-transform (FT) EXAFS spectra of the PdCu SAA and the Pd foil reference; and FIG. 6E: wavelet transforms for the k³-weighted EXAFS signals of the PdCu SAA and the Pd foil reference.

FIGS. 7A to 7D (collectively, FIG. 7) show EXAFS fitting results of Pd K-edge in an exemplary PdCu SAA catalyst and Pd foil reference. FIGS. 7A and 7B: FT Pd K-edge EXAFS spectra in R space and corresponding FT-EXAFS fitted curves of the PdCu SAA (FIG. 7A) and the Pd foil reference (FIG. 7B); FIGS. 7C and 7D: Pd K-edge EXAFS spectra in k space and corresponding FT-EXAFS fitted curves of the PdCu SAA (FIG. 7C) and the Pd foil reference (FIG. 7D).

FIG. 8 show linear sweep voltammetry (LSV) curves of an exemplary PdCu SAA.

FIGS. 9A to 9F (collectively, FIG. 9) show electrochemical, UV-Vis and NMR data of NO₃⁻ reduction data of Cu and exemplary PdCu SAA catalysts. FIGS. 9A to 9C: I-t curves, UV spectra and NMR spectra from Cu catalyst, respectively; and FIGS. 9D to 9F: I-t curves, UV spectra and NMR spectra from exemplary PdCu SAA catalysts.

FIG. 10A to 10F (collectively, FIG. 10) show results of electrocatalytic nitrate reduction performance characterizations. FIGS. 10A and 10B: yield and FE results of an exemplary PdCu SAA catalyst and Cu respectively based on the UV detection method for NH₃; FIGS. 10C and 10D: yield and FE results of the PdCu SAA catalyst and Cu respectively based on the UV detection method for NH₃; FIG. 10E: NMR spectra of produced NH₃ from ¹⁴NO₃⁻ and ¹⁵NO₃⁻ feeding; and FIG. 10F: comparison of FE from different NH₃ detection methods over the PdCu SAA catalyst.

FIG. 11 shows I-t curves and NH₃ FE results of stability test of an exemplary PdCu SAA catalyst.

FIG. 12 are GI-XRD patterns for the PdCu alloy NP and Pd NP on Cu.

FIGS. 13A and 13B (collectively, FIG. 13) show the effect of increasing Pd loading on Cu. FIG. 13A: yield results of PdCu-based catalysts, including an exemplary PdCu SAA catalyst; and FIG. 13B: FE results of the PdCu-based catalysts.

FIG. 14 shows results of an ex situ X-ray photoemission spectroscopy (XPS) analysis in accordance with an embodiment of the present disclosure.

FIG. 15 shows operando Raman Spectroscopy curves during an electrocatalytic NO₃⁻ reduction reaction in accordance with an embodiment of the present disclosure.

FIGS. 16A to 16D (collectively, FIG. 16) show results of single-crystal electrocatalytic performance and density functional theory (DFT) calculations in accordance with an embodiment of the present disclosure. FIG. 16A: GI-XRD spectrum of PdCu SAA based on single-crystal Cu (100); FIG. 16B: Pd K-edge FT EXAFS spectra of single-crystal-based PdCu SAA based on single-crystal Cu (100) and a Pd foil reference; FIG. 16C: NH₃ FE results of single-crystal Cu and single-crystal PdCu SAAs derived from Cu (100), (110) and (111); and FIG. 16D: Gibbs free energy diagram and reaction pathway of various intermediates generated during electrocatalytic NO₃⁻ RR over Cu (100) and PdCu (100) SAA.

FIGS. 17A to 17I (collectively, FIG. 17) show results of characterization of PdCu SAA based on Cu single crystals in accordance with an embodiment of the present disclosure. FIG. 17A: GI-XRD spectra of PdCu SAA based on single-crystal Cu (110) and Cu (111); FIG. 17B: Pd XANES of PdCu SAA based on Cu single crystals and Pd foil reference; FIG. 17C: enlarged spectra from FIG. 17B; FIG. 17D: Pd L-edge FT EXAFS spectra of single-crystal based PdCu SAA based on single-crystal Cu (110) and Pd foil reference; FIG. 17E: Pd FT EXAFS spectra of single-crystal based PdCu SAA based on single-crystal Cu (111) and Pd foil reference; and FIGS. 17F to 17I: Pd EXAFS spectra in k space and corresponding FT-EXAFS fitted curves of Pd foil reference (FIG. 17F) and PdCu SAA based on single-crystal Cu (100) (FIG. 17G), Cu (110) (FIG. 17H) and Cu (111) (FIG. 17I).

FIGS. 18A and 18B (collectively, FIG. 18) show results of electrochemical and UV experiments of single-crystal samples in accordance with an embodiment of the present disclosure. FIG. 18A: I-t curves of Cu single-crystal and corresponding PdCu SAA samples; and FIG. 18B: corresponding UV curves of the I-t tests.

FIG. 19 DFT model of an exemplary PdCu (100) SAA.

### DETAILED DESCRIPTION

It should be understood that the terminology used herein is for the purpose of describing particular embodiments only and is not intended to be limiting.

For the purposes of the present specification and/or claims, and unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth herein are approximations that may vary depending upon the desired properties sought to be obtained by the present invention, inclusive of the stated value and has the meaning including the degree of error associated with measurement of the particular quantity. The term “about” generally refers to a range of numbers that one of ordinary skill in the art would consider as a reasonable amount of deviation to the recited numeric values (i.e., having the equivalent function or result). For example, this term “about” can be construed as including a deviation of ±10 percent of the given numeric value provided such a deviation does not alter the end function or result of the value. Therefore, a value of about 1% can be construed to be a range from 0.9% to 1.1%.

The term “and/or” can mean “and” or “or”. In other words, “and/or” means the listed items are present, or used, individually or in combination.

Unless the context clearly dictates otherwise, the articles “a”, “an” and “the”, when used to identify an element, are not intended to constitute a limitation of just one and will, instead, be understood to mean “at least one” or “one or more”.

In general, a novel PdCu SAA catalyst (also used interchangeably with “PdCu SAA” throughout the present disclosure) and applications thereof are disclosed. For example, the PdCu SAA catalyst can be used for selective electrochemical production of NH₃ from a waste water source.

As would be understood by persons skilled in the art, the term “electrochemical” process or reaction describes a chemical process or reaction involving electron transfer.

As would be understood by persons skilled in the art, the term “Faradaic Efficiency” (FE) can be used to describe the selectivity of a catalyst in an electrochemical reaction and is defined as the amount (moles) of collected product relative to the amount that could be produced from the total charge (i.e. electrons) transferred in the reaction. FE can be expressed as a fraction or a percent. For example, in the present disclosure, FE is used to measure the selectivity of a catalyst for the production of NH₃.

As would be understood by persons skilled in the art, the term “single-atom alloy” (SAA) can be used to refer to a catalyst in which atoms of one metal that serve as dopants are dispersed in or on the surface of a different metal that serves as the host. The metal host can also be understood as the metal substrate. Also as would be understood by persons skilled in the art, “doping” is a way of introducing a small amount of one chemical material (which is generally known as a dopant) into a different host material such as a host chemical material. The term “alloying” would be generally understood by persons skilled in the art as a way of mixing different chemical materials together to form an alloy. In the present disclosure, the terms “doping” and “alloying” are similarly used.

As would be understood by persons skilled in the art, the term “lattice” refers to a three-dimensional structural arrangement of atoms, ions or molecules (i.e. particles). For example, in some embodiments of the present disclosure, the Cu substrate comprises Cu atoms or nanoparticles arranged in lattices.

As used herein, the word “isolated” refers to the isolated atom (Pd) being surrounded by atoms of the host metal (Cu) such that there are no Pd atoms in direct contact with other Pd atoms in the SAA catalyst. In other words, there is a distance between a Pd atom and its neighboring Pd atom(s) such that no Pd—Pd bonds are present in the PdCu SAA catalyst.

As would be understood by persons skilled in the art, the term “nanoparticle” generally refers to a particle having overall dimensions in the nanoscale, for example equal to or under about 100 nm in equivalent spherical diameter, although a nanoparticle need not necessarily be spherical in shape. The term “metal nanoparticle” refers to a nanoparticle having a metal-containing shell formed around a nucleus, in which the shell contains one or more metals, although the one or more metals need not necessarily be in a zero-valent state. Reference to a particular type of metal nanoparticle will generally refer to the metal that is present in its metal shell. For example, the term “copper nanoparticles” refers to metal nanoparticles having a copper-containing shell formed around a nucleus. A metal nanoparticle may be composed of a metallic material, an alloy or other mixture of metallic materials, or a metallic core contained within one or more metallic overcoat layers. Although the nanoparticles described herein are depicted as spheres in the Figures, it would be readily appreciated by persons skilled in the art, the nanoparticles can be in any shape known in the art.

The terms “on”, “onto”, “in”, “into” and the like are all used loosely herein to describe that the Pd atoms are in contact with the Cu substrate but are still available for electrochemical catalytic reactions, and in no way describe the extent or degree of the contact between the Pd atoms and the Cu substrate. Therefore, these terms are not strictly defined and should not be interpreted narrowly. Likewise, the depiction of the position of the Pd atoms relative to the Cu substrate in the Figures is to simply illustrate that the Pd atoms are dispersed in the Cu substrate and does not limit the location of the Pd atoms relative to the Cu substate.

The present disclosure provides a PdCu SAA catalyst. The PdCu SAA catalyst comprises at least one isolated Pd atom dispersed in a surface of a Cu substrate. In some embodiments, the isolated Pd atoms are atomically dispersed in the surface of the Cu substrate. In some embodiments, the Cu substrate comprises Cu nanoparticles.

In some embodiments, the isolated Pd atoms are present in about 0.01—about 0.1 wt % of the PdCu SAA catalyst. A very low amount of Pd in the catalyst would be economically advantageous, since Pd is an expensive noble catalyst.

It is also contemplated that the Cu substrate can be supported by another substrate, which is selected from the group consisting of carbon paper, carbon cloth and an electric conductive metal. In some embodiments, the metal can be selected from the group consisting of titanium, aluminum, nickel, tungsten and silver. It is believed that the further support may increase conductivity of the catalyst during an electrocatalytic reaction. In other embodiments, the Cu substrate is not supported by another substrate (i.e. unsupported form).

The present disclosure also provides an application of a PdCu SAA catalyst in the production of NH₃ via a nitrate reduction. As would be appreciated by those skilled in the art, waste water can possess a high amount of nitrate. Therefore, in another aspect, the present disclosure provides using a PdCu SAA catalyst to reduce nitrate in a nitrate source such as waste water and selectively produce NH₃. In some embodiments, the nitrate reduction may be carried out under neutral media, for example at a neutral pH of about 7.0. In other embodiments, the nitrate reduction may be carried out at room temperature.

To generate NH₃ from NO₃⁻RR, NO₃⁻ usually needs to be adsorbed on the surface of an electrocatalyst and then go through a series of hydrogenation steps (Duca, M. et al. Powering Denitrification: The Perspectives of Electrocatalytic Nitrate Reduction. Energ Environ. Sci. 5, 9726-9742 (2012); Wang, Y., et al. Nitrate Electroreduction: Mechanism Insight, In Situ Characterization, Performance Evaluation, and Challenges. Chem. Soc. Rev. 50, 6720-6733 (2021)). Cu has been found to possess promising nitrate reduction performance due to its excellent *NO₃ adsorption ability (Zhu, T. et al. Single-Atom Cu Catalysts for Enhanced Electrocatalytic Nitrate Reduction with Significant Alleviation of Nitrite Production. Small 16, 2004526 (2020); Wang, Y., et al. Unveiling the Activity Origin of a Copper-based Electrocatalyst for Selective Nitrate Reduction to Ammonia. Angew. Chem. Int. Edit. 59, 5350-5354 (2020); Chen, G.-F. et al. Electrochemical Reduction of Nitrate to Ammonia via Direct Eight-Electron Transfer Using a Copper-Molecular Solid Catalyst. Nat. Energy 5, 605-613 (2020)). However, too weak *H adsorption ability on Cu limits the following hydrogenation steps, resulting in unsatisfied catalysis performance. Although efforts have been made to introduce an additional *H adsorption site in the Cu-based catalyst. For instance, CuNi, CuPd, etc. catalysts have been developed for promoting nitrate reduction, due to the *H generation ability of these second elements (Wang, Y. H. et al. Enhanced Nitrate-to-Ammonia Activity on Copper-Nickel Alloys via Tuning of Intermediate Adsorption. J. Am. Chem. Soc. 142, 5702-5708 (2020); Xu, Y. et al. Cooperativity Of Cu And Pd Active Sites in CuPd Aerogels Enhances Nitrate Electroreduction to Ammonia. Chem. Commun. 57, 7525-7528 (2021); Simpson, B. K. et al. Electrocatalysis of Nitrate Reduction at Copper-Nickel Alloy Electrodes in Acidic Media. Electroanal. 16, 532-538 (2004); Mattarozzi, L. et al. Electrochemical Reduction of Nitrate and Nitrite in Alkaline Media at CuNi Alloy Electrodes. Electrochim. Acta 89, 488-496 (2013)). However, the *H produced on those introduced *H adsorption sites may cross-couple and desorb through the Tafel step: 2M−H→2M+H₂, thus accelerating HER rather than promoting NO₃⁻RR (Sarkar, S. et al. An Overview on Pd-Based Electrocatalysts for the Hydrogen Evolution Reaction. Inorg. Chem. Front. 5, 2060-(2018)).

To avoid the possibility of HER from the *H intercoupling, a PdCu SAA catalyst with isolated atomic Pd atoms dispersed in the surface of a Cu substrate has been developed, in accordance with the present disclosure. While not being limited to any particular theory, it is believed that due to the isolated position of Pd atoms, the produced *H on Pd sites are hard to intercouple, thus avoiding the possible HER occurrence. As a result, the PdCu SAA catalyst can exhibit high selectivity and activity of NH₃ production from NO₃⁻ RR. In one embodiment, the PdCu SAA catalyst exhibits high selectivity with an FE of about 97.1%, accompanied by a NH₃ generation rate of about 15.4 μmol cm⁻² h⁻¹ yield in NO₃ RR.

The present description is further illustrated by the following examples.

### Methods

Chemicals: Toray HCP-060 carbon paper (CP) was purchased from Fuel Cell Store. D₂O, ¹⁵NH₄Cl, Na¹⁵NO₃, NH₄Cl, NaNO₃, NaOH, Na₂PdCl₄, Cu (NO₃)₂*3H₂O, sodium citrate dehydrates, salicylic acid, acetone, ethanol, ethylene glycol, isopropanol (IPA), NaClO aqueous solution, sodium nitroprusside (C₅FeN₆Na₂O), and p-dimethylaminobenzaldehyde were purchased from Sigma. Cu single crystals in the form of thin films with different crystal facets were purchased from MTI company. Deionized water was used in the experiments. All reagents were used without further purification.

Electrodeposition of Cu. Before the electrodeposition process, CP was first cut into a 1 cm×2 cm size and then fully washed with acetone, dilute HCl solution, and water. Electrodeposition was conducted using a three-electrode system, in which CP served as the working electrode with a 1×1 cm² working area. The reference electrode and counter electrode were an Ag/AgCl electrode and a graphite rod, respectively. The electrochemical technique used for electrodeposition was the potentiostat method. The potentiostat electrodeposition was conducted in 50 mL of 6.5 mM Cu (NO₃)₂ aqueous solution with CP as the substrate under the potential of −0.3 V (vs Ag/AgCl) for 30 min. (Chen, Z. Q. et al. Grain-Boundary-Rich Copper for Efficient Solar-Driven Electrochemical CO₂ Reduction to Ethylene and Ethanol. J. Am. Chem. Soc. 142, 6878-6883 (2020)). Under the application of the electric field, Cu²⁺ was reduced into Cu nanoparticles on the CP. Meanwhile, H₂O was oxidized into O₂ at the graphite rod. After the electrodeposition, the CP with Cu nanoparticles was washed with isopropanol and water. After being dried by N₂ flow, the Cu sample was stored in a vacuum or inert gas environment.

Synthesis of PdCu SAA. PdCu SAA was synthesized by the galvanic replacement reaction. The galvanic replacement reaction was spontaneously driven by their reduction potential difference. Typically, 2 mL of 0.1 mg mL⁻¹ Na₂PdCl₄ solution was first prepared using ethylene glycol as solvent. Then, CP with Cu nanoparticles was immersed into the solution under 80° C. for 15 min. After washing with isopropanol and water, the CP with PdCu SAA was dried by N₂ flow and was stored in a vacuum or inert gas environment for further experiments.

Synthesis of PdCu alloy NP and Pd NP on Cu. For the synthesis of PdCu alloy nanoparticle (NP) and Pd NP on Cu, the concentrations of Na₂PdCl₄ solution were increased to 5 and 100 mg mL⁻¹, respectively. The other procedures were the same as that for PdCu SAA on CP described above.

Synthesis of single-crystal PdCu SAA. Single-crystal PdCu SAA was used as a model to study the active sites of the NO₃⁻RR reaction by a PdCu SAA catalyst and whether the catalyst would have facet-dependent behavior. The Pd atom replaces the Cu atoms in the Cu thin films with specific facets (100), (110) or (111). Single-crystal PdCu SAA was synthesized according to a similar procedure as described above for the synthesis of PdCu SAA, which put single-crystal Cu into a dilute Na₂PdCl₄ solution (0.001 mg mL⁻¹) for min at room temperature. The other procedures were the same as that for PdCu SAA on CP.

Material characterization. Scanning electron microscopy (SEM) images were captured on a Hitachi™ S4800 with a working accelerating voltage of 10 kV. Glancing-incidence X-ray diffraction (GIXRD) was measured on a PANalytical X′Pert™ Pro MRD diffractometer with Cu Kα radiation (1.54 Å) at an incidence angle of 0.3°. X-ray photoelectron spectroscopy (XPS) measurements were carried out on a Thermo-VG Scientific ESCALab™ 250 microprobes with a monochromatic Al Kα X-ray source (1486.6 eV). The obtained spectra were calibrated using the C 1s line. The catalyst was sonicated from the CP in IPA solution. Then, the solvent was drop-cast onto ultrathin lacey carbon TEM grids for imaging. Some residue CP was hard to separate from the samples. Aberration-corrected high angle angular dark field scanning transmission electron microscope (AC-HAADF-STEM) tests were carried out on an FEI Titan™ 80-300 HB TEM equipped with energy-dispersive X-ray spectroscopy (EDX) at 300 kV. The HAADF-STEM images were recorded by FEI Titan 80-300 HB TEM/STEM with double aberration correctors operating at 300 kV at the Canadian Center for Electron Microscopy (CCEM). Inductively coupled plasma mass spectrometry (ICP-MS) analyses were carried out on an Agilent™ 8800 triple quadrupole, using He as a collision cell gas, Ge and In as internal standards to correct for instrument drift, and ICP element standards (secondary standards from Delta Scientific Inorganic Ventures; primary calibration standards from Alfa Aesar and Aristar VWR Chemicals BDH) to confirm instrument accuracy (within 3-5%; relative standard deviation for individual sample analyses was ≤12%). UV-Vis absorption spectroscopy was tested on a 11 Shimadzu™ UV-2600i spectrophotometer. Proton nuclear magnetic resonance (1H-NMR) was measured on Bruker Avance™ III 300 MHz. XAS measurements were carried out at the 20-BM and 20-ID-C beamline of Advanced Photon Source (APS), Argonne National Laboratory. The measurements at the Pd K-edge were performed in fluorescence mode using a Lytle detector. The XAS data were analyzed using the software package Athena™. The EXAFS data was fitted using the software package Artemis™. Pd foil was applied for reference and calibration samples. In this fitting data, CN represents the coordination numbers of identical atoms; R is assigned as the interatomic distance; δ² is considered as Debye-Waller factors. The fitting parameters strictly comply with all experimental requirements.

Electrochemical NO₃⁻RR measurements. All electrochemical tests were measured on Autolab™ PGSTAT 204 electrochemical workstations at room temperature with IR corrected. A three-electrode system was fabricated with the prepared PdCu-based materials, platinum wire, and saturated calomel electrode (SCE) severing as the working electrode, the counter electrode, and the reference electrode, respectively. A gas-tight H-type electrochemical cell equipped with a piece of 211 Nafion membrane was employed to conduct the electrochemical reaction. A platinum wire was in the anode compartment alone to avoid the electrochemical oxidation of produced NH₃. Before NO₃⁻RR tests, the 211 Nafion membrane was firstly activated in 5% H₂O₂, H₂O, 0.5 M H₂SO₄, and H₂O for 20 min, respectively, and then soaked in water at 80° C. for 12 h (Hanifpour, F., et al. Preparation of Nafion Membranes for Reproducible Ammonia Quantification in Nitrogen Reduction Reaction Experiments. Angew. Chem. Int. Edit. 59, 22938-22942, (2020). The synthesized CP with PdCu SAA catalyst directly served as the working electrode with an electrode holder. The NO₃⁻RR catalytic activities were evaluated using the potentiostatic technique under selective potential for one hour in 0.5M Na₂SO₄ with 600 ppm NaNO₃ solution under an Ar gas environment. All the potential values are presented in RHE unless otherwise stated. For the electrochemical test of single-crystal PdCu SAA samples, the bulk single-crystal PdCu SAA was connected to electrode holder through Cu foil. To avoid the interference of Cu foil on the electrochemical signal, an inert Kapton tap was used to totally cover the Cu foil.

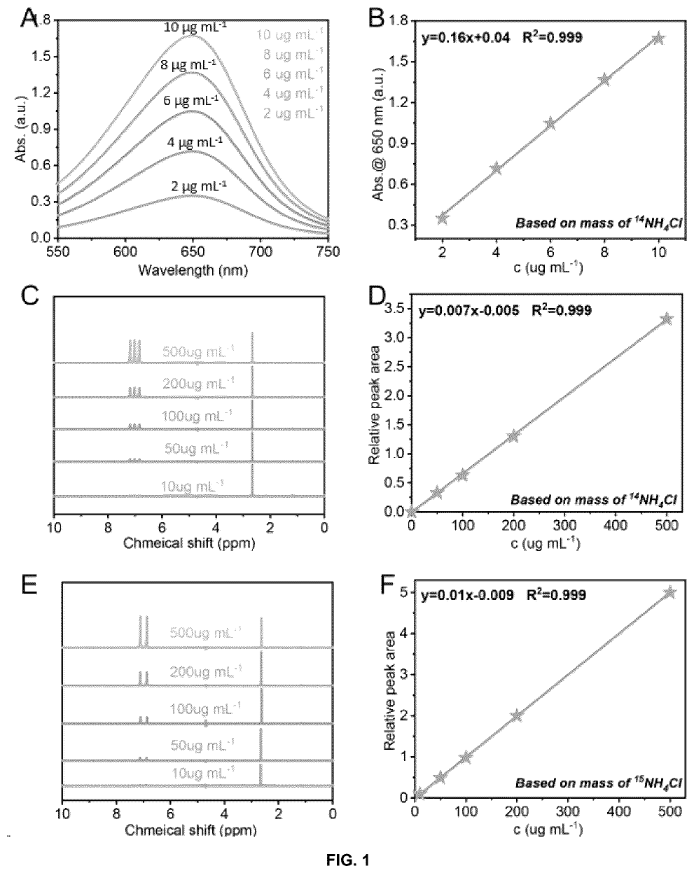

Determination of NH₃using UV-Vis method. The UV-Vis method for NH₃ concentration determination was modified from the indophenol blue method (Zhu, D., et al. Photo-Illuminated Diamond as A Solid-State Source of Solvated Electrons in Water for Nitrogen Reduction. Nat. Mater. 12, 836-841 (2013)). In detail, 2 mL of the electrolyte was taken out after the electrocatalytic reaction and was diluted 5 times. Then, 2 mL of the diluted solution was added to 2 mL of a 1 M NaOH solution containing salicylic acid and sodium citrate. Then, 1 mL of 0.05 M NaClO and 0.2 mL of 1 wt % C₅FeN₆Na₂O were also added to the above-mixed solution. The UV-Vis absorption spectrum was measured after 2 h. The concentration of indophenol blue was determined using the absorbance at the wavelength of 655 nm. The concentration-absorbance curves were calibrated using a standard ammonia nitrate solution with a series of concentrations in 0.5 M Na₂SO₄. The fitting curve (y=0.160x +0.040, R²=0.999) shows good linear relationship between the absorbance values and NH₃ concentrations (FIGS. 1A and 1B).

Determination of NH₃ using NMR method. The NMR method was based on ¹H-NMR. To better detect the NH₄⁺ using the NMR method, the solution was acidized to pH about 3. Typically, 630 μL electrolyte was taken out after the electrocatalytic reaction and then acidized by adding 5 μL concentrated hydrochloric acid. After that, 100 μL D₂O with certain DMSO was added to the mixed solution and the solution was then transferred into an NMR tube for the test. All NMR spectra were obtained by 128 scans. DMSO showed a peak at 2.6 ppm and served as the internal standard. The ¹H-NMR spectra of ¹⁴NH₄⁺ showed triple peaks in the range of 7.2 ppm to 6.8 ppm. The concentration of NH₄⁺ was determined by the peak area ratio between NH₄⁺ (triplet) and DMSO. The concentration-NMR peak area ratio curves were calibrated using a standard NH₄Cl solution with a series of concentrations in 0.5 M Na₂SO₄. The fitting curve (y=0.007x−0.005, R²=0.999) shows good linear relationship between the absorbance values and NH₃ concentrations (FIGS. 1C and 1D).

Isotope labeling experiments. The isotopic labeling experiments were conducted using 15NaNO₃ as the feeding in 0.5 M Na₂SO₄. All other experimental operations were the same as that using NaNO₃ as described above. Especially, the ¹⁵NH₄⁺ standard curve was built using ¹⁵NH₄Cl with a series of concentrations in 0.5 M Na₂SO₄. The ¹H-NMR spectra of ¹⁵NH₄⁺ showed double peaks in the range of 7.2 ppm to 6.8 ppm. The fitting curve (y=0.010x−0.009, R²=0.999) shows good linear relationship between the absorbance values and NH₃ concentrations (FIGS. 1E and 1F).

Calculations of NH₃ formation rate and FE. The FE and yield for NH₃ can be calculated as follows:

$$yield = \frac{{c}_{NH 3} \times V \times {M}_{NH 3}}{A \times t}$$

$$FE = \frac{{c}_{NH 3} \times V \times 8 \times F}{{\int }_{0}^{t} idt}$$

Where C_{NH3} is the determined NH₃ concentration; V is the volume of electrolyte in the cathode compartment, typically 25 mL; M_{NH3} is the molecular weight of ammonia, 17 g mol⁻¹ for ¹⁴NH₃ and 18 g mol⁻¹ for ¹⁵NH₃; A is the geometric surface area of the electrode, 1 cm²; tis the time of electrolysis, 3600 s; Fis the Faraday constant, i.e., 96485 C mol⁻¹. The reported values of yield and FE were calculated based on three separate measurements under the same conditions.

Operando Raman spectroscopy. The operando Raman spectroscopy measurements were performed using a Renishaw inVia™ Reflex system and an Autolab PGSTAT204 electrochemical workstation. The electrochemical cell was homemade by Teflon™ with a quartz window between the sample and objective. The working electrode was immersed into the electrolyte through the wall of the cell, and the electrode plane was kept perpendicular to the laser. A platinum wire and Ag/AgCl electrode were served as the counter and reference electrodes, respectively. IT curves were conducted at 0, −1.1, −1.2, and −1.3 V vs. Ag/AgCl.

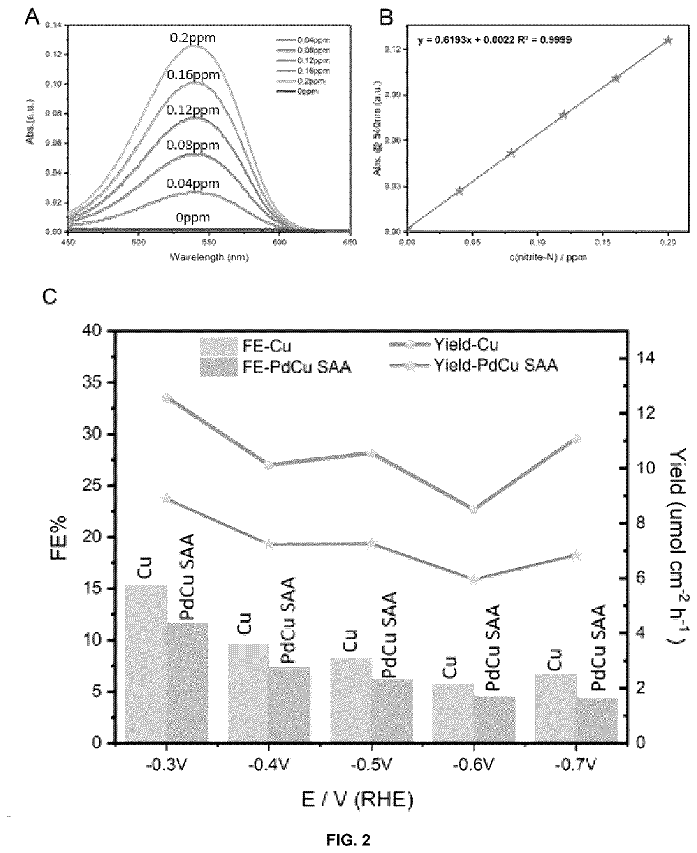

Determination of NO₂⁻ using UV-vis-absorption method. The method of NO₂⁻ using the UV-vis-absorption method was similar to a previously reported method (Wang, Y., et al. Unveiling the Activity Origin of a Copper-based Electrocatalyst for Selective Nitrate Reduction to Ammonia. Angew. Chem. Int. Edit. 59, 5350-5354 (2020)). A mixture of p-aminobenzenesulfonamide (4 g), N-(1-naphthyl)ethylenediamine dihydrochloride (0.2 g), ultrapure water (50 mL), and phosphoric acid (10 mL, ρ=1.70 g/mL) was used as a color reagent. A certain amount of electrolyte was taken out from the electrolytic cell and diluted to 5 mL to the detection range. Next, 0.1 mL of color reagent was added into the aforementioned 5 mL solution and mixed uniformity, and the absorption intensity at a wavelength of 540 nm was recorded after sitting for 20 min. The concentration-absorbance curves were calibrated using a standard ammonia nitrate solution with a series of concentrations in 0.5 M Na₂SO₄. The fitting curve (y=0.6193x+0.0022, R²=0.9999) shows a good linear relationship between the absorbance values and NO₂⁻ concentrations (FIGS. 2A and 2B). The FE of NO₂⁻ was then calculated.

DFT calculations. DFT calculations were performed using the Vienna Ab initio Simulation Package (VASP) with projector-augmented wave pseudopotentials (Kresse, G. et al. Efficient Iterative Schemes for Ab Initio Total-Energy Calculations Using a Plane-Wave Basis Set. Phys. Rev. B 54, 11169-11186 (1996); Kresse, G. et al. Norm-Conserving and Ultrasoft Pseudopotentials for First-Row and Transition-Elements. J. Phys. Condens. Matter 6, 8245-8257 (1994); Blochl, P. E. Projector Augmented-Wave Method. Phys. Rev. B 50, 17953-17979(1994)). The Perdew-Burke-Ernzerhof (PBE) exchange-correlation functional within the generalized gradient approximation (GGA) was chosen in consideration of a balance between accuracy and computational cost (Perdew, J. P. et al. Atoms, Molecules, Solids, and Surfaces-Applications of the Generalized Gradient Approximation for Exchange and Correlation. Phys. Rev. B 46, 6671-6687 (1992)). Van der Waals interactions were considered using DFT-D3 with the Becke-Jonson damping method. The plane wave energy cutoff was 400 eV for each of the slabs. These periodic slabs were separated by 20 Å vacuum space along the z direction to isolate interactions between replicas. The Brillouin zone was sampled on a 3×2 ×1 Monkhorst-Pack k-point grid (Monkhorst, H. J. et al. Special Points for Brillouin-Zone Integrations. Phys. Rev. B 13, 5188-5192 (1976)). For each slab, the top two layers of the slabs and adsorbates were fully relaxed until the maximum forces converged to 0.05 eV/Å. Free energy for the three catalysts was obtained following the method reported in the literature (Wu, Z. Y. et al. Electrochemical Ammonia Synthesis via Nitrate Reduction on Fe Single Atom Catalyst. Nat. Commun. 12, 2870 (2021)). The free energy correction was implemented for each species by conducting an additional frequency calculation with the same function. To avoid abnormal entropy contribution, frequencies less than 50 cm⁻¹ were set to 50 cm⁻¹.

### Example 1: Synthesis and STEM Characterizations

PdCu SAA was prepared through a spontaneous galvanic replacement reaction driven by the reduction potential difference between Na₂PdCl₄ and Cu, as described above, using a method modified from those reported in the literature (Du, C. et al. Novel Pd13Cu13S7 Nanotubes with High Electrocatalytic Activity towards Both Oxygen Reduction and Ethanol Oxidation Reactions. Cryst Eng Comm 18, 6055-6061 (2016); Xia, X. H. et al. 25th Anniversary Article: Galvanic Replacement: A Simple and Versatile Route to Hollow Nanostructures with Tunable and Well-Controlled Properties. Adv. Mater. 25, 6313-6333, (2013)).

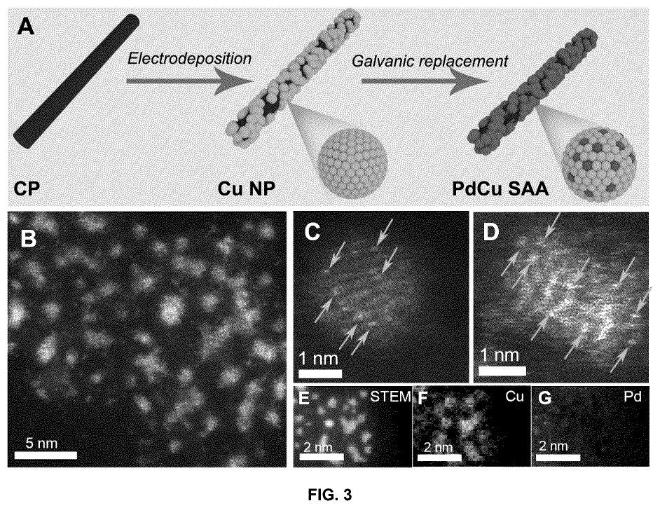

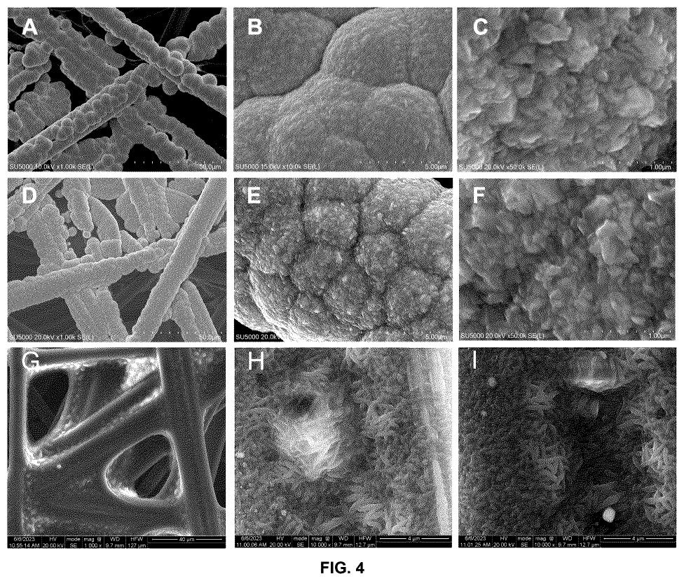

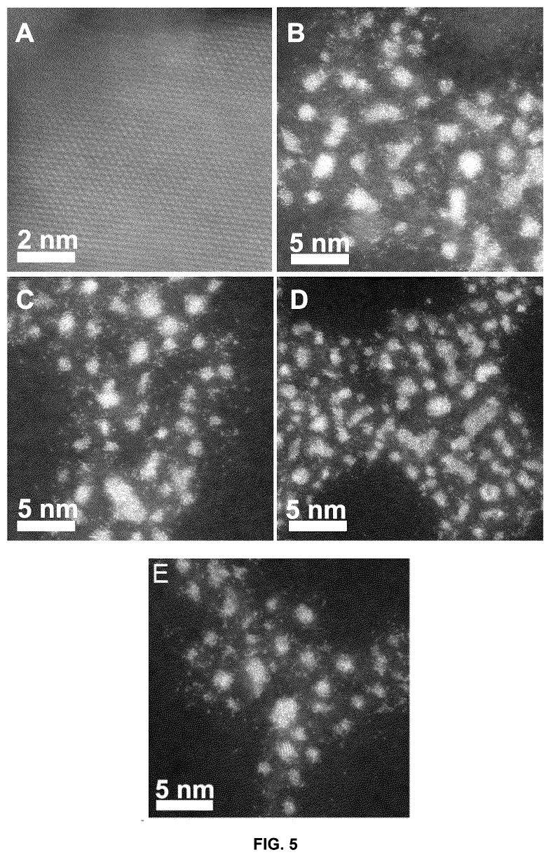

As shown in the general reaction scheme in FIG. 3A, Cu nanoparticles were firstly electrodeposited on the CP substrate, and then immersed into a dilute 0.1 mg mL⁻¹ Na₂PdCl₄ ethylene glycol solution for 15 min under 80° C. Here, ethylene glycol served as solvent for the reaction, due to its mild reduction ability to prevent the possible oxidation of Cu. As seen from the SEM images (FIG. 4), no obvious change was observed in the morphology of Cu after its galvanic replacement reaction with Na₂PdCl₄. However, many bright atoms could be found in the darker lattice from the AC-HAADF-STEM images (FIGS. 24 3B to 3D and FIG. 5). Based on the Z-contrast difference between Cu and Pd atoms, those darker contrast belongs to the Cu lattice while the brighter contrast is Pd atoms, as marked by the arrows (FIGS. 3C and 3D). These AC-HAADF-STEM images directly demonstrated the atomic dispersion of Pd atoms in the PdCu SAA. The STEM-EDX mapping further proved the co-existence of Pd and Cu elements in the PdCu SAA (FIGS. 3E to 3G). The STEM-EDX mapping image of the Pd signal looks relatively weak, due to its low content of 0.1 wt % as determined by the inductively coupled plasma mass spectrometry (ICP-MS) analysis.

### Example 2: Structural Characterization and Barder Charge Analysis

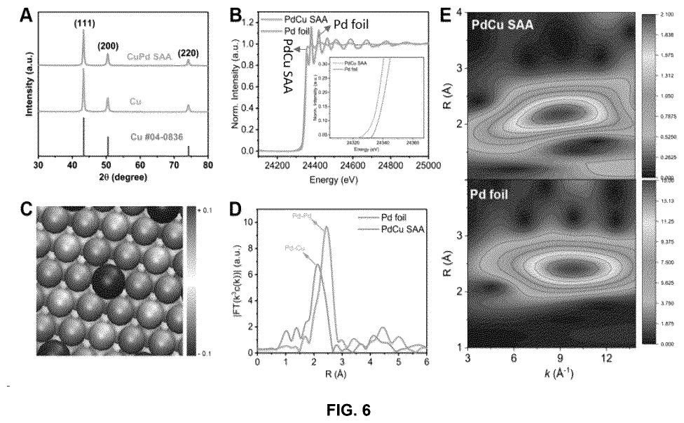

To study the crystal structure, GI-XRD test was conducted for both the PdCu SAA catalyst synthesized in accordance with Example 1 above and Cu. Both samples showed obvious diffraction peaks of Cu (111) (200) and (220) planes (FIG. 6A). No Pd peaks appeared in the GI-XRD spectrum of the PdCu SAA, indicating that no Pd crystalline phase formed in the PdCu SAA, agreeing well with the AC-HAADF-STEM results.

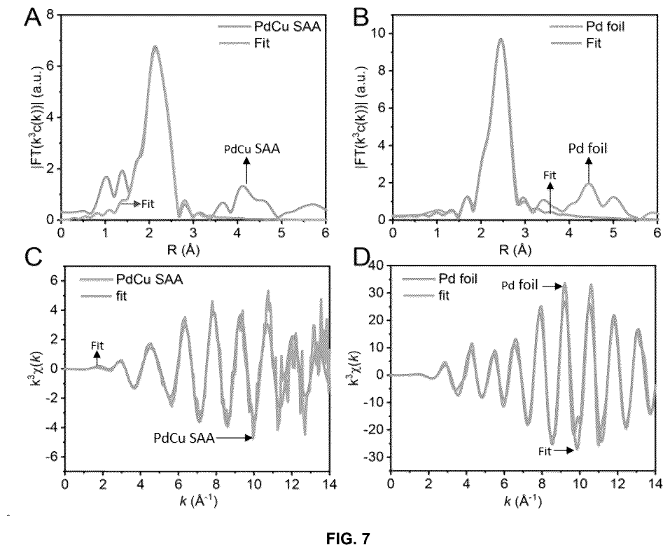

Core-level X-ray absorption structure (XAS) was conducted to study the local coordination structure of Pd and Cu in the PdCu SAA. As shown in the Pd K-edge XANES and EXAFS (FIG. 6B), the white line (an intense absorption in the near edge in the X-ray absorption spectra) of the PdCu SAA showed a slight shift to lower energy for the adsorption edge (E₀) compared to that of a Pd foil used as the reference, indicating that Pd in the PdCu SAA had a charge transfer with the Cu substrate and carried a negative charge. The Bader charge analysis of the PdCu SAA with Cu (100) revealed that isolated Pd atoms carried substantially negative charges (FIG. 6C), confirming the experimental observations. Moreover, the FT of the k³-weighted EXAFS curve of the Pd K-edge of the PdCu SAA showed only one main peak at 2.1 Å, suggesting that the Pd atoms possessed only one coordination (i.e. Pd—Cu), which was different from the Pd—Pd coordination in the Pd foil at 2.4 Å (FIG. 6D, FIG. 7 and Table 1). These results indicate that the Pd exists in a PdCu SAA catalyst in single-atom form with Pd—Cu coordination (Pei, G. X., et al. Isolation of Pd atoms by Cu for Semi-hydrogenation of Aetylene: Effects of Cu Loading. Chinese J. Catal. 38, 1540-1548 (2017); Jiang, L. Z. et al. Facet Engineering Accelerates Spillover Hydrogenation On Highly Diluted Metal Nanocatalysts. Nat. Nanotechnol. 15, 848-853 (2020)).

In addition, high-resolution wavelet-transform EXAFS (WT-EXAFS) in k and R spaces were performed to determine the dispersion state of the Pd atoms in the PdCu SAA and Pd foil reference (FIG. 6E). The WT-EXAFS oscillations showed the main peak at about 8.9 Å⁻¹, which could be attributed to the Pd—Cu coordination for the PdCu SAA, while the main peak at around 9.8 Å⁻¹ belonging to the Pd—Pd coordination in the Pd foil reference. Combined with the EXAFS analysis and AC-HAADF-STEM images described herein, the single-atom dispersion of the Pd atoms in the PdCu SAA can be confirmed.

TABLE 1
Fitted EXAFS parameters at the Pd K-edge
based on Cu nanoparticles and Pd foil

| | | | | δ² | | R |
|---|---|---|---|---|---|---|
| | Shell | CN | R (Å) | (10⁻³) | ΔE | factor |
| Pd | Pd—Pd | 12 | 2.74 ± 0.03 | 6.1 ± 0.3 | 7.0 ± 0.3 | 0.003 |
| foil | | | | | | |
| PdCu | Pd—Cu | 10.5 ± 1.1 | 2.65 ± 0.05 | 9.2 ± 0.7 | 8.3 ± 1.7 | 0.01 |
| SAA | | | | | | |

CN: coordination numbers of identical atoms; R: interatomic distance; δ²: Debye-Waller factors; ΔE: energy shift. R factor: goodness of fit. Error bounds that characterize the structural parameters obtained by the EXAFS spectroscopy were estimated as CN ± 20%; R ± 2%; ΔE ± 20%. Persons skilled in the art would appreciate that “shell” is a term of art in EXAFS and generally describes atoms at approximately the same distance from the central atom.

### Example 3: Electrocatalytic Nitrate Reduction

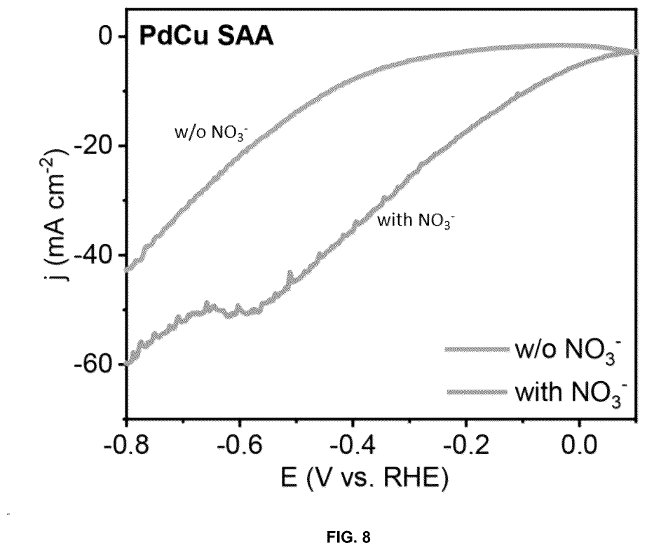

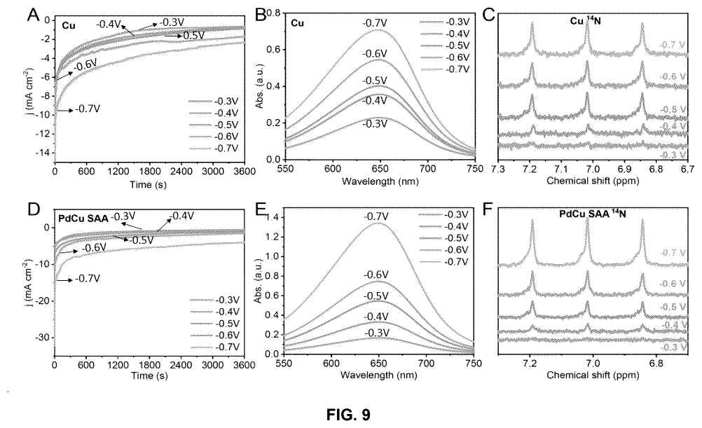

To evaluate the electrocatalytic NO₃⁻RR performance of a PdCu SAA in accordance with the method described herein, LSV was firstly measured in an H-cell with 0.5M Na₂SO₄ as the neutral electrolyte. The current density of the PdCu SAA greatly increased after the addition of 600 ppm NO₃ electrolyte, indicating its high activity toward NO₃⁻RR (scan rate: 10 mV s⁻¹) (FIG. 8).

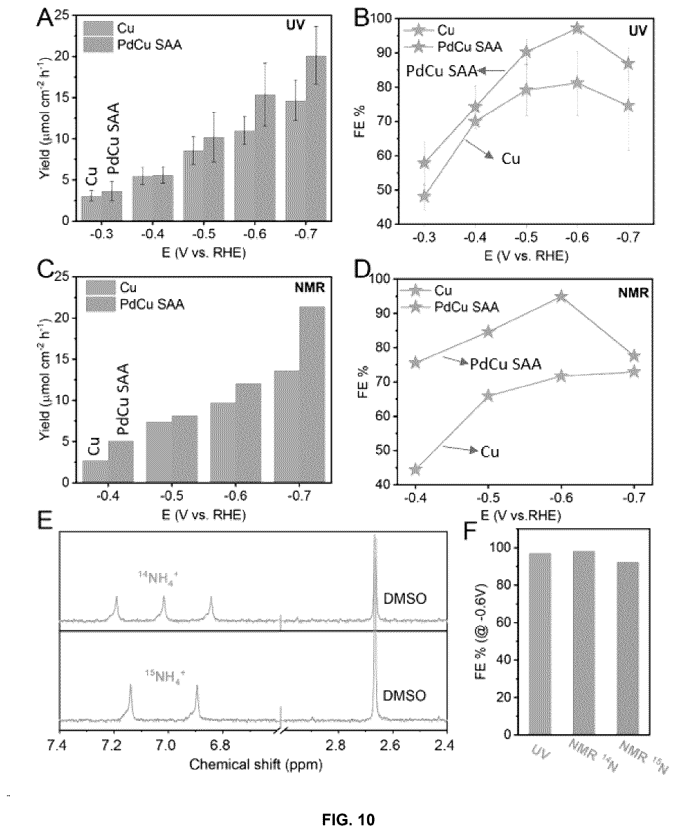

To further quantify the activity of electrocatalytic NO₃⁻RR, chronoamperometry was measured for NO₃⁻RR under different applied potentials and the produced ammonia was confirmed by both UV-Vis spectrophotometer and NMR (FIG. 9). Given the high solubility of NH₃ in water, the electrolyte after electrolysis was taken out and measured to quantify the NH₃ production. Indophenol blue colorimetry was firstly adopted to quantify the NH₃ concentration in the electrolyte with the assistance of a UV-Vis spectrophotometer (UV-Vis) (FIGS. 1A and 1B). The yields of both the PdCu SAA catalyst and Cu increased with the increase of applied negative potentials (FIG. 10A), while the FE reached the maximum at −0.6V (FIG. 10B). In FIG. 10A, for each bar pair, the left bar was for Cu and the right bar was for the PdCu SAA catalyst (same applicable to FIG. 10C). Specifically, the PdCu SAA catalyst exhibited the highest FE of 97.1% with a yield of 15.4 μmol cm⁻² h⁻¹ under −0.6V, performing better than that of Cu (FE of 81.2% with a yield of 11.0 μmol cm⁻² h⁻¹) (FIG. 10B). The highest FE for the PdCu SAA catalyst was 94.9% with a yield of 12.1 μmol cm⁻² h⁻¹, much better than that of Cu (FE of 71.7% with a yield of 9.7 μmol cm⁻² h⁻¹) based on the NMR quantification method.

Further, the selectivity of the PdCu SAA catalyst for NH₃ outperformed most of the reported NO₃⁻RR electrocatalysts in the neutral electrolyte as shown in Table 2 below.

TABLE 2
Comparison with recently reported catalysts under neutral media.

| Catalyst | Electrolyte | FE of NH₃ | Reference |
|---|---|---|---|
| PdCu SAA | 0.5M Na₂SO₄ | 97.1% ± 1.2% | Present disclosure |
| Pd/TiO₂ | 1M LiCl | 92% | Energy Environ. Sci., |
| | | | 2021, 14, 3938-3944 |
| Co—Fe@Fe₂O₃ | 0.1M Na₂SO₄ | 85.2 ± 0.6% | PNAS 2022 Vol. 119 No. |
| | | | 6 e2115504119 |
| polycrystalline | 0.5M Na₂SO₄ | 94% | Nano Energy 97 (2022) |
| copper | | | 107124 |
| Cu⁰/GDYNA | 0.5M Na₂SO₄ | 81% | Nano Today 43 (2022) |
| | | | 101431 |
| NbOx | 0.5M K₂SO₄ | 95% | Green Chem., 2022, |
| | | | 24, 1090-1095 |
| RuNi-MOFs | 0.1M Na₂SO₄ | 73% | J. Mater. Chem. A, |
| | | | 2022, 10, 3963-3969 |
| Co₂AlO₄/CC | 0.1M PBS | 93% | Chem. Eng. J., 2022, |
| | | | 435: 135104. |
| Fe/Ni₂P | 0.2M K₂SO₄ | 94% | Adv. Energy Mater., |
| | | | 2022, 12(13): 2103872. |
| Pd-NDs/Zr-MOF | 0.1M Na₂SO₄ | 58% | Nano Lett. 2022, 22, 6, |
| | | | 2529-2537 |
| Fe₂TiO₅ | PBS solution | 88% | Angew. Chem. Int. |
| Nanofibers | | | Ed. 2023, e202215782 |
| Cu-cis-N₂O₂ SAC | 0.5M Na₂SO₄ | 88% | Adv. Mater. 2022, 34, |
| | | | 2205767 |
| SN Co—Li⁺/PCNF | 0.5M Na₂SO₄ | 73% | Adv. Energy Mater. 2022, |
| | | | 12, 2202247 |
| Cu/Cu₂O NWAs | 0.5M Na₂SO₄ | 81% | Angew. Chem. 2020, |
| | | | 132, 5388-5392 |
| CuFe | 0.1M K₂SO₄ | 87% | ChemSusChem, 2021, |
| | | | 10.1002/cssc.202100127 |
| CuPd aerogels | 0.5M K₂SO₄ | 90% | Chem. Commun., 2021, |
| | | | 57, 7525-7528 |
| copper nanoplates | 0.5M K₂SO₄ | 82% | J. Mater. Chem. A, |
| | | | 2021, 9, 16411-16417 |

To cross verify the performance of the PdCu SAA catalyst, NMR was used to determine the NH₃ production. The PdCu SAA catalyst and Cu showed a similar performance-potential trend, namely yield increased with the increasing applied potential while FE reached a maximum at −0.6V (FIGS. 10C and 10D, 9C and 9F).

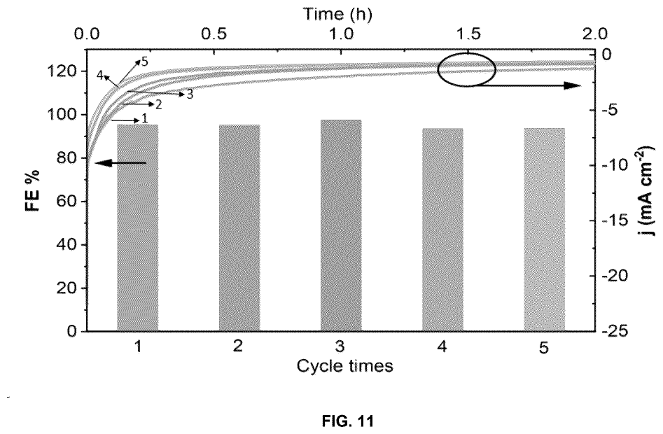

Considering the possible disturbance of NH₃ from the atmospheric environment and confirming the source of nitrogen in the reaction, a ¹⁵N isotope experiment was also conducted with a Na¹⁵NO₃ feed to confirm the source of NH₃ production (FIGS. 10E and 10F). The electrolyte after electrolysis of Na¹⁵NO₃ showed the apparent doublet peaks in the range of 7.2 ppm to 6.8 ppm, due to H atoms binding to ¹⁵N atoms with the spin-spin coupling. In contrast, Na¹⁴NO₃ electrolysis produced triplet peaks due to the symmetric distribution of H atoms binding with ¹⁴N atoms (FIG. 10E). It was also worth noting that the PdCu SAA catalyst showed a very similar FE value (92.3%) in Na¹⁵NO₃ electrolysis compared to that of Na¹⁴NO₃ electrolysis (97.1%) (FIG. 10F). The PdCu SAA catalyst also showed good stability, keeping the FE above 95% during a 10 h test (FIG. 11). For the 10 h test, the electrolyte was changed after each cycle test to 2 h for each cycle and there were 5 cycles in total.

The FE and yield of NO₂⁻ were also measured as described in the “Methods” section above (FIG. 2). The PdCu SAA catalyst showed a lower FE and yield of converting NO₃⁻ to NO₂⁻ compared with Cu, consistent with the high FE of converting NO₃⁻ to NH₃ using the PdCu SAA catalyst (FIG. 10).

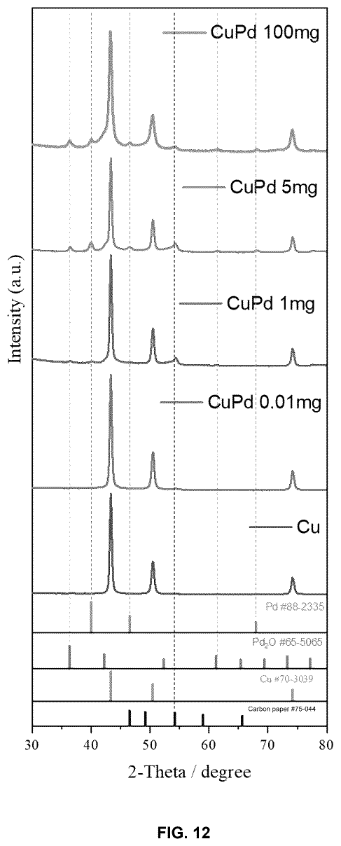

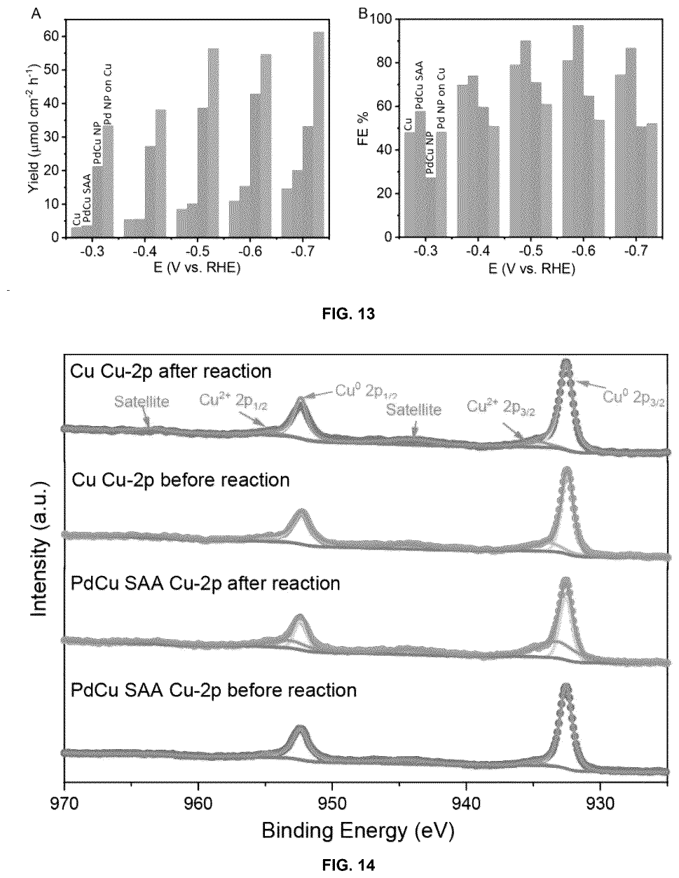

To investigate the effect of the amount of Pd loading, PdCu alloy NP and Pd NP on Cu were prepared by increasing the Pd content using the methods described in the “Methods” section above. XRD patterns showed that the formation of Pd—Pd and Pd—Cu bonds was observed with the increased in Pd loading (FIG. 12). Although the NH₃ yield 8 increased after the increase of Pd content, the FE decreased (FIG. 13). In FIGS. 13A and 13B, for each bar set, from left to right, the bars represented Cu, PdCu SAA, PdCu alloy NP and Pd NP, respectively. Without being limited to any particular theory, it is believed that based on these results, a high NH₃ selectivity would be due to the highly atomic dispersion of the Pd in the Cu nanoparticles in the PdCu SAA catalyst.

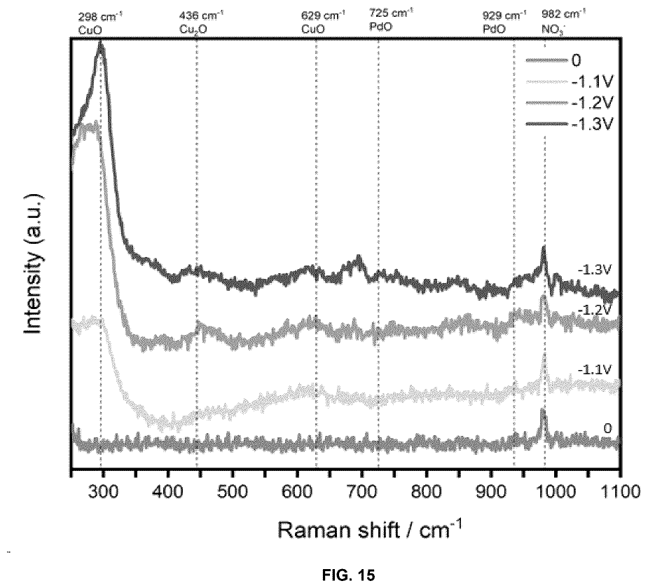

To investigate the electronic state changes, ex situ XPS tests were carried out (FIG. 14) and operando Raman spectroscopy (FIG. 15). According to the ex situ XPS analysis, it is postulated that Cu gets oxidized after the reaction (FIG. 14). To verify, operando Raman spectroscopy was performed under the given potentials. The Cu species showed no signal in the Raman spectroscopy. With the increase of the applied voltage, the characteristic peaks of CuO, Cu₂O, and PdO gradually appeared (FIG. 14). The following characteristic peaks were observed for the PdCu SAA samples: (1) CuO at 298 and 629 cm⁻¹, (2) Cu₂O stretching at 436 cm⁻¹, and (3) PdO at 725 and 929 cm⁻¹, indicating that both the oxidation states of Cu and Pd increased during the reaction. Without being limited to any particular theory, it is postulated this may be due to the production of the OH* radical from H₂O (Mu, S., et al. Hydroxyl Radicals Dominate Reoxidation of Oxide-Derived Cu in Electrochemical CO₂ Reduction. Nat. Commun. 13, 3694 (2022)).

The above characterization and electrochemical results showed that a PdCu SAA catalyst having single isolated Pd atoms dispersed in a surface of a Cu substrate could improve the NO₃⁻RR performance.

### Example 4: Single Crystal Electrocatalytic Performance and DFT Calculations

To explore the active sites of the NO₃⁻RR reaction by a PdCu SAA catalyst and whether the catalyst would have facet-dependent behavior, a single crystal experiments were carried out. Single-crystal PdCu SAAs using Cu (100), (110), and (111) were prepared in accordance with the method described above.

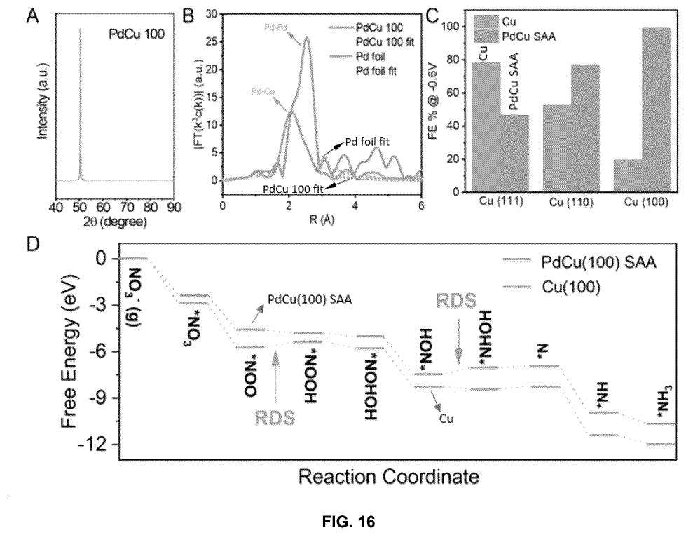

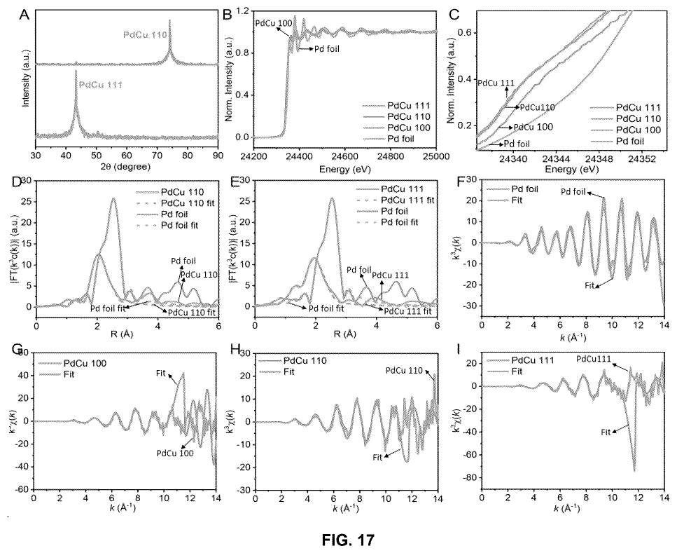

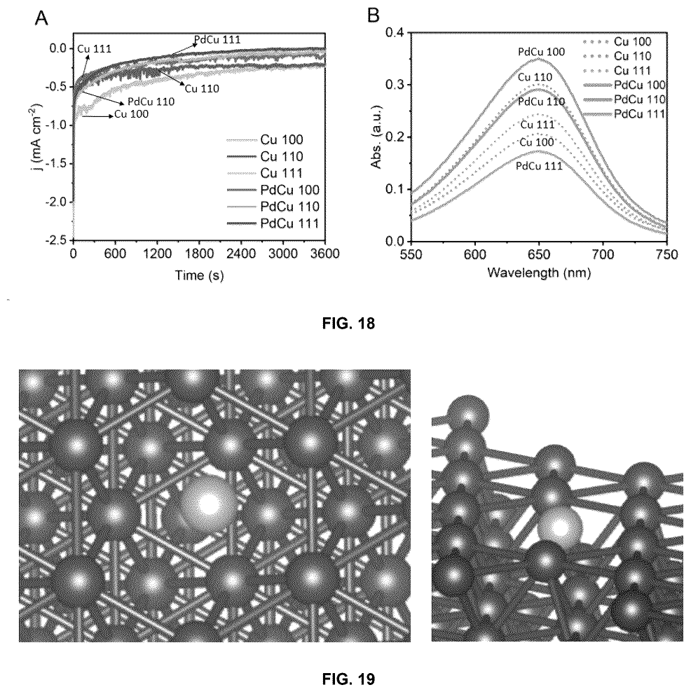

The GI-XRD spectrum of the PdCu SAA catalyst of FIG. 6A shows the Cu's polycrystalline nature, including Cu (100), (110), and (111) Bragg reflections. To confirm the most active facet with the Pd single atom, the Pd single atom was doped on single-crystal 9 Cu with different crystal facets, namely Cu (100), Cu (110), Cu (111). XRD results showed that the Pd doping did not produce a new crystal peak, indicating no Pd crystals were formed (FIG. 16A and FIG. 17A). EXAFS results further showed the single-atom dispersion of Pd atoms in the single-crystal Cu (FIG. 16B and FIGS. 17B to 17I). The white line of all PdCu single crystal samples showed shift to lower energy for the adsorption edge (E₀) compared to that of the Pd foil reference (FIGS. 17B and 17C), suggesting electron transfer from Cu to Pd due to the formation of the Pd—Cu bond. This agreed well with the results of Barder charge analysis in FIG. 6C. The smallest shift of PdCu (100) shifts among all PdCu single crystal samples could mean the lowest negative charge of Pd in PdCu (100) (FIG. 17C). It was postulated that this could indicate the Pd atoms on Cu (100) surface will not strongly adsorb *H and hinder the following hydrogenation step on neighboring Cu sites. The detailed fitting results are shown in Table 3 below. The PdCu (100) SAA single crystal exhibited the highest NH₃ production FE of 99% under −0.6 V (FIG. 16C and FIGS. 18A and 18B). Those results indicated that Cu (100) could be the most active crystal facet as a substrate for isolated Pd single atoms p for the NO₃ RR reaction. In FIG. 16C, for each bar pair the left bar was for Cu and the right bar was for the PdCu SAA.

DFT calculations were conducted to investigate the reaction mechanism based on PdCu (100) SAA model shown in FIG. 19 (light sphere being Pd and dark spheres being Cu). As shown in the reaction pathway (FIG. 16D), it is believed that NO₃⁻ is adsorbed on the single-atom Pd site and forms *NO₃ with an energy decrease. The N—O bond in *NO₃ is then cleaved to produce *NOO. Next, two H atoms are bonded with O to form *NOOH and *NOHOH successively. With two further hydrogenation steps, the *NOHOH is transformed into *NHOH. After losing one H₂O molecule, the active *N is formed. Subsequently, the *NH₃ is formed through a series of hydrogenation steps from *N and then finally desorbed from the catalyst.

Without being limited to any particular theory, it is believed that the RDS for Cu (100) is the hydrogenation of *NOO with an energy barrier of 0.39 eV, while the RDS for PdCu (100) is the formation of *NHOH with an energy barrier of only 0.10 eV. As a result, the reaction can be facilitated over PdCu (100), appearing to be in line with the experimental observation.

TABLE 3
Fitted EXAFS parameters at the Pd K-edge
for PdCu SAA based on Cu single crystals

| | | | | δ² | | R |
|---|---|---|---|---|---|---|
| | Shell | CN | R (Å) | (10⁻³) | ΔE | factor |
| PdCu | Pd—Cu | 8.8 ± 0.8 | 2.54 ± 0.1 | 4.5 ± 0.4 | 9.7 ± 0.6 | 0.02 |
| 100 | | | | | | |
| PdCu | Pd—Cu | 8.4 ± 0.7 | 2.53 ± 0.1 | 3.6 ± 0.8 | 9.2 ± 0.8 | 0.01 |
| 110 | | | | | | |
| PdCu | Pd—Cu | 8.1 ± 1.0 | 2.49 ± 0.2 | 6.5 ± 0.7 | 9.3 ± 0.5 | 0.02 |
| 111 | | | | | | |

CN: coordination numbers of identical atoms; R: interatomic distance; δ²: Debye-Waller factors; ΔE: energy shift. R factor: goodness of fit.

### CONCLUSIONS

As described herein, a PdCu SAA catalyst has been developed and exhibits a high FE (for example, about 97.1% with a yield of 15.4 μmol cm⁻² h⁻¹) towards NH₃ production in NO₃⁻RR under mild neutral media. Single crystal experiments and DFT calculations have revealed that the atomic Pd sites on Cu (100) facets are the most likely active sites. In addition, with the introduction of single-atom Pd, the RDS on Cu would change from *NOO→*NOOH with an energy barrier of about 0.39 eV to *NOH→*NHOH with an energy barrier of about 0.10 eV on the PdCu SAA catalyst.

According to the present disclosure, there is provided an effective catalyst for NH₃ production from nitrate reduction in mild neutral media, which can have application in NO₃ ⁻RR for nitrate nutrition recovery from a nitrate source such as waste water and other selective electrocatalytic applications.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the present disclosure and are not intended to be drawn to scale or to be limiting in any way. The scope of the claims appended hereto should not be limited by the preferred embodiments set forth in the above description but should be given the broadest interpretation consistent with the present specification as a whole. The disclosures of all references in the present description herein are incorporated herein by reference in their entirety.

1. A palladium copper (PdCu) single-atom alloy (SAA) catalyst for nitrate reduction, comprising a Cu substrate and at least one isolated Pd atom dispersed in a surface of the Cu substrate.

2. The PdCu SAA catalyst of claim 1, wherein when there are more than one isolated Pd atoms, the isolated Pd atoms are present in the form of individual isolated atoms dispersed in the surface of the Cu substrate.

3. The PdCu SAA catalyst of claim 1, wherein the isolated Pd atoms are present in no more than about 0.1% total weight of the catalyst.

4. The PdCu SAA catalyst of say claim 1, wherein the isolated Pd atoms are present in the about 0.01 to 0.1% total weight of the catalyst.

5. The PdCu SAA catalyst of claim 1v, wherein the Cu substrate comprises Cu nanoparticles.

6. The PdCu SAA catalyst of claim 5, wherein the Cu nanoparticles have an average size of about 100 nm in diameter.

7. The PdCu SAA catalyst of claim 1, wherein the Cu substrate is polycrystalline.

8. The PdCu SAA catalyst of claim 1, wherein the catalyst exhibits at least about 97.1% Faradaic Efficiency with a yield of about 15.4 μmol cm⁻² h⁻¹ towards a production of NH₃.

9. The PdCu SAA catalyst of claim 1, wherein the Cu substrate is supported by a support selected from the group consisting of carbon paper, carbon cloth and an electric conductive metal support.

10. The PdCu SAA catalyst of claim 9, wherein the electric conductive metal support is selected from the group consisting of titanium, aluminum, nickel, tungsten and silver.

11. A method of nitrate reduction in a nitrate source, the method comprising:
contacting a PdCu SAA catalyst comprising at least one isolated Pd atom dispersed in a surface of a Cu substrate with the nitrate source; and
reducing nitrate in the nitrate source to produce NH₃ in the presence of the PdCu SAA catalyst.

12. The method of claim 11, wherein said contacting comprises feeding the PdCu SAA catalyst to the nitrate source.

13. The method of claim 11, wherein said contacting comprises feeding the nitrate source to the PdCu SAA catalyst.

14. The method of claim 11, wherein the method is carried out at a neutral pH.

15. The method of claim 11, wherein the method is carried out at room temperature.

16. The method of claim 11, wherein the nitrate source is waste water.
